(19) United States
(12) Patent Application Publication
(10) Pub. No.: US 2010/0082733 A1
(43) Pub. Date: Apr. 1, 2010

(54) EXTENSIBLE REMOTE PROGRAMMATIC ACCESS TO USER INTERFACE

(75) Inventors: Michael S. Bernstein, Redmond, WA (US); Brendan McKeon, Seattle, WA (US); Masahiko Kaneko, Fall City, WA (US); Vidhya Sriram, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/241,292

(22) Filed: Sep. 30, 2008

(51) Int. Cl. G06F 15/16

(52) U.S. Cl. 709/203

(57) ABSTRACT

A remote automation system is described herein that allows application accessibility information to be used remotely and extended to allow custom UI elements to be automated. The remote automation system receives a request at a remote computer for automation data related to an application running on the remote computer. The remote automation system requests automation data from the application running on the remote computer and serializes the automation data for transmission to the client computer. The system transmits the serialized automation data to the client computer in response to the request. When the client computer receives the response, the system deserializes the automation data and provides the deserialized automation data to a local application on the client computer. Thus, the remote automation system allows users to view applications running on a remote system but run accessibility applications locally.

### BACKGROUND

Application remoting technologies allow a user at a client computer to access applications running at a remote computer. For example, Microsoft Terminal Server allows a client computer to display user interface elements from a remote computer in a window on the client computer. Application remoting technologies typically sends copies of drawing operations across a network (e.g., line output, text output, and other primitives), or create a bitmap of the remote computer screen that visually represents the user interface of the remote computer and transmit the bitmap to the client computer. The client computer executes the drawing operations or displays the bitmap in a window on the client computer. If the screen or resolution of the remote computer is larger than that of the client computer, then the application remoting technology may display a portion of the remote screen along with scroll bars or other user interface elements for navigating around the larger screen.

User Interface (UI) Automation is an application programming interface (API) that presents user interface elements to a client application, such as through a tree of nodes, each node representing a UI element, and providing access to structure, properties, interactivity and events for those nodes. For example, Microsoft .NET 3.0 includes User Interface Automation (UIA) for Microsoft Windows Vista and other operating systems that support Microsoft Windows Presentation Foundation (WPF). UI Automation provides programmatic access to most user interface (UI) elements on the desktop, enabling assistive technology products such as screen readers to provide information about the UI to end users and to manipulate the UI by means other than standard input. UI Automation also allows automated test scripts to interact with the UI.

An Assistive Technology (AT) program running on a client machine typically does not have access to remote UI. For example, a screen reader (an AT program that reads text or other screen elements aloud) can only read information from programs that are running on the local client computer. If a user connects to a remote machine (e.g., via Microsoft Terminal Services, or equivalent technology), the screen reader cannot read the remote programs. The screen reader also cannot read information from the programs locally, because there is information the screen reader typically relies on that is only on the remote machine. For example, a screen reader can typically obtain text or other information from a UI element by sending a request to it (e.g., extracting the text from a Win32 pushbutton by sending the WM_GETTEXT message). However, this method does not work for remoted UI, since there is no actual button locally to send the message to, only an “empty” graphical representation of the button. The actual button—along with its internal state—is on the remote machine and there is no way to send a message to it.

A user might be able to run a second screen reader on the remote machine and transmit the sound to the client computer, but such a solution is slow and error-prone, often leading to audio glitches (e.g., when packets are dropped or experience varying latency). In addition, applications often have user interface elements or accessible properties that go beyond those predefined by UIA, but there is no way to get non-standard information from these elements remotely. Thus, applications running remotely face an additional challenge about how to expose their custom accessible properties. Moreover, customers sometimes use custom hardware (such as Braille readers and blow-tube switches) to access their software programs, but that custom hardware is only connected to the client machine and so cannot interact successfully with programs on a remote computer without some additional assistance.

### SUMMARY

A remote automation system is described herein that allows application accessibility information to be used remotely and extended to allow custom UI elements to be automated. A client initiates a request for information about a UI element on a remote computer. The remote automation system receives the request at the remote computer for automation data related to an application running on the remote computer. The remote automation system requests automation data from the application running on the remote computer and serializes the automation data into one or more packets for transmission to a client computer. The system transmits the serialized automation data to the client computer in response to the request. When the client computer receives the response, the system deserializes the automation data and provides the deserialized automation data to a local application on the client computer. Thus, the remote automation system allows users to view applications running on a remote system but run accessibility applications locally to experience higher fidelity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the remote automation system, in one embodiment.

FIG. 2 is a block diagram that illustrates a typical single-computer UI automation operating environment, in one embodiment.

FIG. 3 is a block diagram that illustrates a multi-computer UI automation operating environment, in one embodiment.

FIG. 4 is a flow diagram that illustrates the serialization of automation data from a remote computer to a client computer, in one embodiment.

FIG. 5 is a flow diagram that illustrates the deserialization of automation data received from a remote computer, in one embodiment.

FIG. 6 is a block diagram that illustrates third-party extension of the remote automation system, in one embodiment.

FIG. 7 is a display diagram that illustrates automation data translation performed by the remote automation system, in one embodiment.

### DETAILED DESCRIPTION

A remote automation system is described herein that allows application accessibility information to be used remotely and extended to allow custom UI elements to be automated. A client initiates a request for information about a UI element on a remote computer. The remote automation system receives the request at the remote computer for automation data related to an application running on the remote computer. For example, a screen reader running on a client computer may request information about an application running via application remoting. The remote automation system requests automation data from the application running on the remote computer. For example, the system may query the application through a standard accessibility interface. The system collects automation data received from the application and serializes the automation data into one or more packets for transmission to the client computer. For example, the system may copy the automation data into a contiguous buffer. The system transmits the serialized automation data to the client computer in response to the request. For example, the system may send the data over a Microsoft Terminal Services communication channel. When the client computer receives the response, the system deserializes the automation data to produce an in-memory representation of the automation data from the received response. The system provides the deserialized automation data to a local application on the client computer. For example, a screen reader may receive automation data that provides text to be read from an application running on the remote computer. Thus, the remote automation system allows users to view applications running on a remote system but run accessibility applications locally to experience higher fidelity.

This process also operates in the reverse direction. For example, a user at a client computer may want to push a button using a speech commanding system. The speech system sends a request to the local accessibility system on the client computer, which serializes the request and send it to the remote system using the remote automation system. When the remote computer receives the request, it deserializes the request and pushes the button on the remotely running application.

The following paragraphs describe various aspects of the remote automation system, including: the method of collecting accessibility information on one machine and transmitting it to another machine, an extensibility mechanism so that applications can provide custom accessibility data over the remoting channel in addition to system-provided data types, and a translation mechanism to allow differences in the machine interfaces (like differences in the location of controls due to the remote computer running in a movable window on the client computers, or differences in screen resolution and size between local and remote computers) to be resolved transparently to applications running on the client.

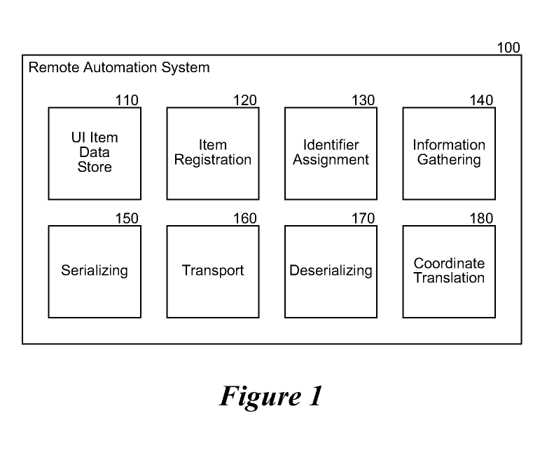

FIG. 1 is a block diagram that illustrates components of the remote automation system, in one embodiment. The remote automation system 100 includes a UI item data store 110, an item registration component 120, an identifier assignment component 130, an information gathering component 140, a serializing component 150, a transport component 160, a deserializing component 170, and a coordinate translation component 180. Each of these components is described in further detail herein.

The UI item data store 110 stores information about each user interface property, event, and pattern that is accessible through the automation system. The UI item data store 110 contains the tables described further herein, including both pre-defined UI items and application-provided UI items. When a user requests information about a particular type of item, the system 100 accesses the UI item data store 110 to retrieve information about items. The UI item data store 110 may only store in-memory metadata about available controls, and may request additional information from the controls themselves as needed. For example, the UI item data store 110 may store a control's name and description, but query the control for information about the methods that it supports.

The item registration component 120 handles requests from applications to register new UI item types. For example, an application can add new UI item properties, events, and patterns as described further herein. The item registration component 120 receives information about the item, such as a name, description, and identifier, and adds the new item to the UI item data store 110. As noted above, the item registration component 120 may only receive metadata about each item, and forward requests for additional information to the item itself.

The identifier assignment component 130 assigns identifiers to metadata of new UI items registered by applications. For example, the identifier assignment component 130 may assign identifiers to each of the descriptors, methods, and property definitions of a new UI item.

The information gathering component 140 gathers automation information from an application running on the remote computer. For example, the component 140 may gather information about displayed buttons, icons, text, and so forth that AT applications may be interested in for providing accessible experiences for users. The information gathering component 140 may interface with proxies that translate accessibility data from common formats understood by applications into a format presented by the remote automation system 100. For example, one proxy may consume data provided by the IAccessible interface implemented by an application to provide standardized accessibility data.

The serializing component 150 marshals the gathered automation information into a format suitable for transmission over a network. For example, the component 150 may flatten data into a single buffer that can be transmitted using a stream- or packet-based protocol (e.g., Transmission Control Protocol (TCP) or Uniform Datagram Protocol (UDP)) over the wire.

The transport component 160 transmits the marshaled data over a network or other communication medium (e.g., a named pipe, wirelessly, and so forth) to a client computer. Another instance of the transport component 160 receives the transmitted data and provides the data to the deserializing component 170. The transport component 160 may use existing transport technologies, such as Microsoft Terminal Services or an independent transport technology based on common networking techniques.

The deserializing component 170 receives serialized automation data and deserializes the data into an in-memory representation similar to the automation data before it was transmitted over the network. An instance of the deserializing component 170 may exist at both the client computer and remote computer. For example, at the remote computer, the deserializing component 170 receives requests from the client computer for information about particular UI elements. At the client computer, the deserialization component 170 provides the response to a UI automation API on the client computer that presents the data to applications in a format similar to UI automation data from applications running on the local machine. For example, applications may be unaware through the UI automation API of whether the automation data is coming from an application running remotely or locally.

The coordinate translation component 180 handles any inconsistencies in the automation data caused by differences in the remote computer and the client computer. For example, the remote computer and client computers may have different screen resolutions, or the client computer may be displaying the remote desktop in a window that is not in the same location as it would be on the remote computer. The coordinate translation component 180 modifies the coordinates at the client computer to reflect the actual location of UI items on the client computer so that AT applications on the client computer can interact as expected with the remote applications. The coordinate translation component 180 also handles other properties, such as the enabled and focused states that may be impacted by the state of the local remote application window on the client computer. For example, if the local remote application window is disabled, it is as though all remote UI is also disabled, regardless of the state of each UI element received from the remote computer.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

### Collecting and Transmitting Automation Data

Automation technology typically uses interprocess communication to pass information between an application and an assistive technology process. For example, a screen reading application may read a document in a word processing application by loading a module into the word processing application's process that passes information about the word processing application user interface to the screen reading application's process. Those of ordinary skill in the art will recognize various standard mechanisms for interprocess communication, such as named pipes, shared memory, network ports, and so on.

In some cases, the application author implements one or more standard interfaces that provide information about the application's user interface. For example, the IAccessible Component Object Model (COM) interface previously introduced as part of the Microsoft Active Accessibility (MSAA) platform provided a standard mechanism for applications to provide user interface and other accessibility information to assistive technology applications.

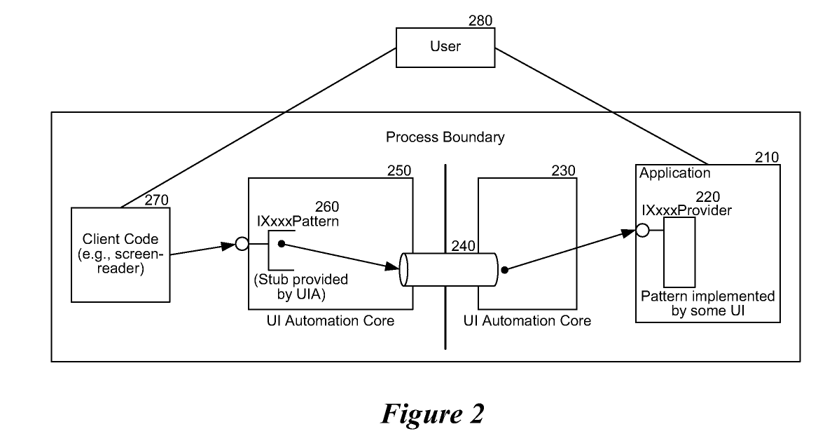

FIG. 2 is a block diagram that illustrates a typical single-computer UI automation operating environment, in one embodiment. An application 210 contains a user interface and one or more custom or built-in providers, such as provider 220. For example, a table provider may be included that knows how to hierarchically provide row and column data to AT applications. A UI Automation Core instance 230 associated with the application 210 passes automation data over a named pipe 240 or other interprocess communication medium to another UI Automation Core instance 250 running in another process. The second UI Automation core instance 250 includes a pattern interface 260 for interpreting the automation data provided by the provider 220. The UI Automation core instance 250 provides the automation data to a client application 270, such as a screen reader, magnifier, or other AT application. A user 280 interacts with the application 210 and the client application 270.

In some embodiments, the remote automation system leverages existing application interprocess communication to gather information for automating an application remotely and convert this information into a protocol that can be sent between computers over any standard packet- or stream-based protocol. For example, the system may gather the information described above and format the data in a manner suitable for transmission over a network. In some embodiments, the system uses the ability of Microsoft Terminal Services to include custom, application-specific data in the transmission stream between computers, but other remote channels can be used as well. Marshalling (similar to serialization) is the process of transforming the memory representation of an object to a data format suitable for storage or transmission. The opposite of marshalling is called unmarshalling (also known as deserialization). The remote automation system marshals data received from an application, transmits the data to a remote client computer, and the client computer unmarshals the data and presents it to a local assistive technology application.

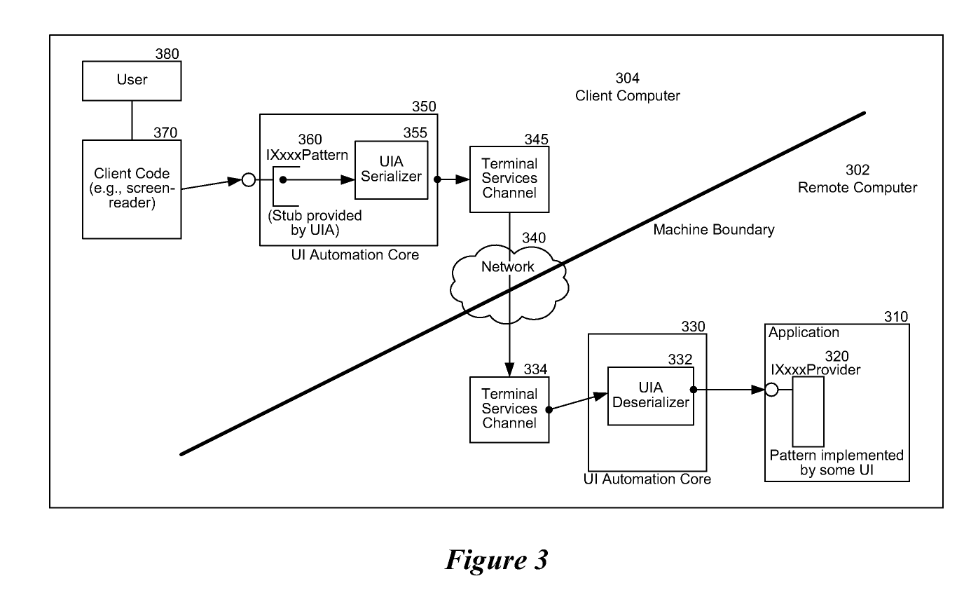

FIG. 3 is a block diagram that illustrates a multi-computer UI automation operating environment, in one embodiment. A remote computer 302 is running an application 310 and a user 380 is using the application from a client computer 304. The application 310 contains a user interface and one or more custom or built-in providers, such as provider 320. For example, the application 310 could be a word processing application and the provider could be a page information interface that provides information about pages of a document that a blind user wants to read using a screen reader on the client computer 304. A UI Automation Core instance 330 includes a serialization component 332 that packages automation data from the application 310 for transmission over network 340. The system may use existing technology for the transport of the serialized data, such as a terminal services channel that includes a remote component 334 and a client component 345. Other transports can also be used, and ultimately pass the automation data over a network or other connection, such as network 340.

At the client computer 304, another UI Automation Core instance 350 is running that includes a deserialization component 355 and a pattern interface 360 for interpreting the automation data provided by the provider 320. The deserialization component 355 reverses the process of the serialization component 332, creating a local copy of the automation data. The UI Automation core instance 350 provides the automation data to a client application 370, such as a screen reader, magnifier, or other AT application. A user 380 at the client computer 304 can simultaneously view the remote application (e.g., in a Terminal Services window) and benefit from the AT application 370 running locally at high fidelity to provide information about the application 310 running remotely.

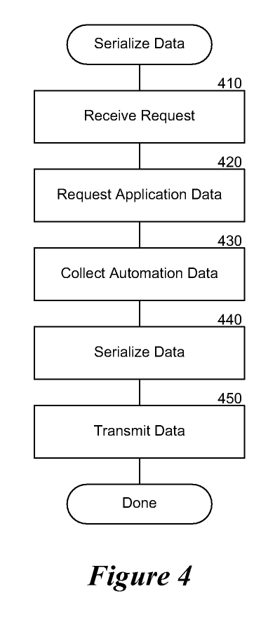

FIG. 4 is a flow diagram that illustrates the serialization of automation data from a remote computer to a client computer, in one embodiment. In block 410, the system receives a request over the network at the remote computer for automation data. For example, the system may receive the request through a Microsoft Terminal Services virtual channel. In block 420, the system requests automation data from an application running on the remote computer. For example, the system may query a word processing application for automation data. In block 430, the system collects automation data received from the application. For example, the system may build a hierarchical data structure in memory containing the automation data provided by the application. In block 440, the system serializes the automation data into one or more packets for transmission to the client computer. For example, the system may gather information associated with the automation data and place it in a contiguous buffer for transmission. In block 450, the system transmits the serialized automation data to the remote computer. For example, the system may provide the serialized data to a Microsoft Terminal Services virtual channel.

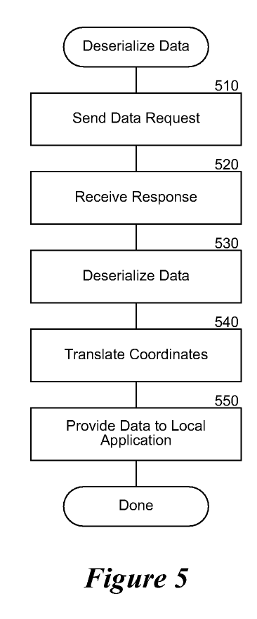

FIG. 5 is a flow diagram that illustrates the deserialization of automation data received from a remote computer, in one embodiment. In block 510, the system sends a request for automation data from a client computer to a remote computer. The request may include information about an application or window currently being displayed by the client computer of an application running on the remote computer. In block 520, the system receives a response including serialized automation data for one or more remote applications. For example, the automation data may be received over a network and include properties, events, and patterns each having an identifier and representing a different UI item of the remote application. In block 530, the system deserializes the automation data, creating an in-memory representation from the received network packets. For example, the system may create a hierarchical data structure with logically arranged UI items. For example, a dialog box may have child items representing buttons. In block 540, the system translates any coordinates or other machine-specific information in the received automation data to be suitable for the client computer. For example, the system may adjust screen coordinates for the location of a window on the remote computer to the window's position as it is displayed on the client computer. In block 550, the system provides the translated automation data to a local application on the client computer. For example, the system may provide the data through an automation API to a screen reader.

### Extending Automation Data

In some embodiments, the remote automation system allows applications to specify custom data to be sent over the communication channel between the remote and client computer in addition to built-in data. The remote automation system categorizes the types of UI information provided by applications as properties, events, and patterns. Properties refer to information about a particular UI element. For example, a button may have a name (e.g., “OK”) and a type (e.g., “button”). Events refer to notifications provided by a UI element about changes to the UI element. For example, a button may provide a notification that the button has received the input focus or that the button has been clicked. Patterns refer to functionality provided by a UI element, such as ways a user can interact with the UI element. For example, a button may have a “click” pattern that when invoked performs an action defined for the button.

In some embodiments, the remote automation system provides an extensibility model in addition to a baseline UI automation API. The automation API is a “contract” between accessibility tools and business applications about the type and format of data that the API provides. Accessibility tools or many types of software automation programs use the pre-defined programming interface to access and manipulate the user interface of business applications. Usually, the programming interface and data types are predefined by the operating system (OS) and introducing of new data types involve costly and infrequent changes to the OS and applications. With the extensibility model provided by the Remote automation system, applications can extend the API to include new types in addition to those predefined by the OS.

In some embodiments, the remote automation system provides one or more internal tables that track metadata about pre-defined properties, patterns, and events supported by the system. Pre-defined pattern, property, and event identifiers may be defined as based-indices into these tables. A lookup from identifier to table entry is performed by subtracting a base value from the identifier value to give an offset into the table. The system checks the resulting offset against a range of valid offsets to ensure the offset is within the known range.

In some embodiments, applications can add properties, events, and patterns to the remote automation system by adding information to the internal tables. Making properties, patterns, and events extensible involves modifying the static tables with a dynamic structure. The system can continue to use an index-lookup for pre-defined elements, and use an add-on linked-list (with simple linear lookup) for registered values added by applications. This keeps the cost of looking up internal values fast and the overhead to look up custom values relatively fast.

The method of adding values to the tables varies depending on the type of element. For properties, adding a general element property involves adding an entry to the property table with a property identifier, expected type (used in error checking and marshalling), and default value. For events, there is not associated metadata, so applications provide an identifier and GUID. Patterns (and pattern properties) are a bit more complex, because the application provides executable information related to the patterns.

Clients (i.e., accessibility or software automation tools) use a client interface object (e.g., IValuePattern) that has getters for cached and current properties, as well as methods. Providers (i.e., applications that support programmatic access to the UI via UI Automation) implement a provider interface (e.g., IValueProvider) that has getters for each property, as well as methods. To support a new pattern, an application supplies code that handles each of these participants. To support the client API object, the application that registers a pattern supplies a factory for creating instances of a client wrapper. This wrapper implements the client API, and forwards all the property getter requests and methods calls to an IUIAutomationPatternInstance interface that is provided by the remote automation system. The remote automation system then takes care of remoting and marshalling the call as necessary. Following is an example of an IValueProvider interface. IValueProvider and other interfaces are custom interfaces defined by an application to include whatever functionality the application is providing through the pattern.

```
interface IValueProvider : IUnknown
{
  HRESULT SetValue (
    [in] LPCWSTR val );
  [propget] HRESULT Value (
    [out, retval] BSTR * pRetVal );
  [propget] HRESULT IsReadOnly (
    [out, retval] BOOL * pRetVal );
};
```

Following is an example of the IUIAutomationPatternInstance interface implemented by the remote automation system that represents a pattern object. The client API wrapper sits on top of this, and implements all property/method calls in terms of GetProperty and CallMethod.

```
interface IUIAutomationPatternInstance : IUnknown
{
  [local] HRESULT GetProperty(
    [in] UINT index, // a property index
    [in] BOOL cached,
    [in] enum UIAutomationType type,
    [out] void * pPtr);
  [local] HRESULT CallMethod(
    [in] UINT index, // must be a method index
    [in] const struct UIAutomationParameter * pParams,
    [in] UINT cParams);
};
```

On the provider side, the application supplies a pattern handler object that essentially performs the reverse function of the client wrapper: the system forwards the property and method requests to this object in the form of an index plus an array of parameters, and the handler calls the appropriate method on the target object. In this scenario, the remote automation system takes care of serialization, marshalling, cross-process communication, and thread-handoff issues. The Client Wrapper and Pattern Handler map between interface methods calls with positional arguments (from the client API or to the provider interface) and a method index plus array of parameters (from the Remote automation system).

Following is an example of the IUIAutomationPatternHandler interface that is implemented by a third-party pattern supplier. This interface is responsible for returning a client API wrapper object and for unmarshalling property and method requests to an actual provider instance. The system calls CreateClientWrapper to return a wrapper to the client. The system supplies a pointer to the IUIAutomationPatternInstance described above, through which the client wrapper calls. The system calls Dispatch to dispatch a property getter or method call to an actual provider interface object. The third party implementation casts pTarget as appropriate, and calls the property getter or method indicated by index, passing the parameters from the pParams array, and casting appropriately.

```
interface IUIAutomationPatternHandler : IUnknown
{
  HRESULT CreateClientWrapper (
    [in] IUIAutomationPatternInstance * pPatternInstance,
    [out] IUnknown ** pClientWrapper );
  [local] HRESULT Dispatch (
    [in] IUnknown * pTarget, // target provider, already QI'd
    [in] UINT index, // may be property or method index
    [in] const struct UIAutomationParameter * pParams,
    [in] UINT cParams);
}
```

The remote automation system assigns an identifier to each property, pattern, and event so that each can be programmatically distinguished. Thus, when an application registers a new, pattern, property, or event the system assigns a new identifier value to it.

In some embodiments, the same numeric space is used for all types of identifiers within the system. For example, no property identifier has the same value as any event or pattern identifier. This simplifies the creation of identifiers and aids in debugging. Identifiers only need to be unique within a process. To satisfy this condition, the system uses a “global ticket” to assign new values.

While this technique works for pattern identifiers, property and event identifiers have additional requirements so that they can be used as winevent identifiers with Microsoft .NET. They are to be in a specific range and unique within a session, so that client and server processes see the same winevent values. This restriction does not apply to pattern identifiers, since they do not need to be squeezed into a DWORD. Rather, the full GUID can be sent across processes, so clients and servers can assign their local value independently. In some embodiments, the system obtains property and event identifiers will be obtained as ATOM values, by generating a string from the GUID and registering that as an ATOM. This ensures a value that is both unique within a session, and usable as a winevent.

In some embodiments, the system uses GUIDs to identify properties and patterns in cross-process communication. If one process requests a pattern, property, or event from another process using a GUID that the target does recognize (i.e., has not yet been registered), the system returns a “not supported” error.

In some embodiments, the remote automation system provides each pattern with its own set of IDs for method dispatches. The argument to the method dispatch is a specific pattern object (e.g., an invoke method request is only made against a specific invoke pattern object, not against a generic object), so there is no ambiguity that needs to be resolved.

In some embodiments, the remote automation system provides a process-level scope to added UI items for local AT applications and an interface-level scope for remote AT applications. For local AT applications, items registered against one IUIAutomation object are effectively globally within a process. For remote AT applications, items are scoped to a specific IUIAutomation. The main reason for this is that registered items need to be usable by providers, and providers do not operate with respect to any given IUIAutomation instance. Therefore, the registered items need to be available globally (however the registration is not effective outside of the process).

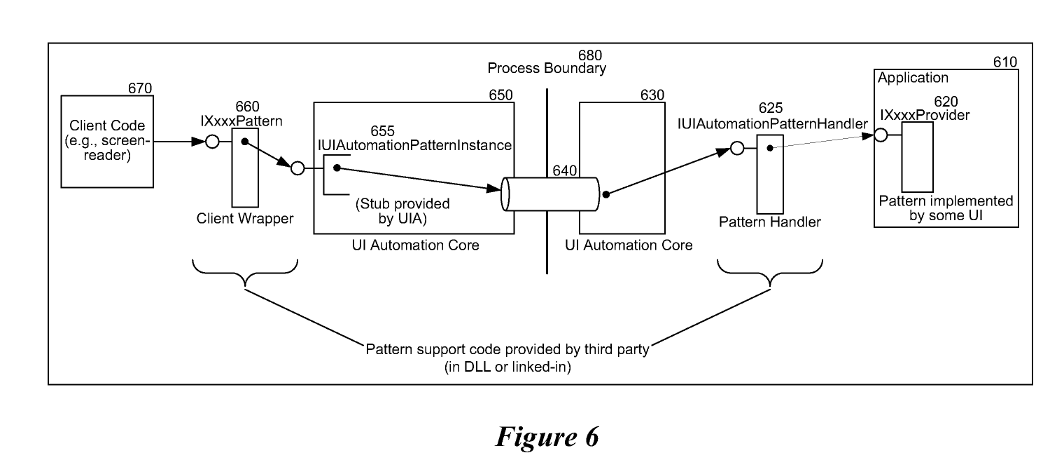

FIG. 6 is a block diagram that illustrates third-party extension of the remote automation system, in one embodiment. In the example illustrated, a third party has added a new UI pattern. For example, the third party may have added a pattern for providing a tooltip when a user hovers over a UI item, such as a button. Although the example is shown operating across a process boundary 680 in a manner similar to FIG. 2, the example can also work across a network boundary in a manner similar to FIG. 3. An application 610 contains a user interface and one or more custom or built-in providers, such as provider 620. For example, a table provider may be included that knows how to hierarchically provide row and column data to AT applications. A third-party pattern handler 625 provides the executable instructions for carrying out actions associated with a custom pattern. A UI Automation Core instance 630 associated with the application 610 passes automation data over a named pipe 640 or other communication medium to another UI Automation Core instance 650 running in another process. The second UI Automation core instance 650 includes a stub pattern interface 655 communicating with an external third-party pattern 660. The third-party pattern interprets the automation data provided by the handler 625 and provides any client-side interaction. The UI Automation core instance 650 provides the automation data to a client application 670, such as a screen reader, magnifier, or other AT application.

The UI Automation Core shown in 650 and 630 may be provided by the operating system or other automation platform that allows for third-party extension. The UI Automation Core establishes communication between client and provider applications, and the UI Automation Core of both ends of the communication moderates extensibility registrations. The diagram demonstrates registration of extended control patterns using the remote automation system's extensibility model. Similar practices can be performed for other UI items, such as events and properties, but these items do not involve registration of the client and provider side interfaces or stub code provided by the UI Automation Core.

### Translating Automation Data

Transmitting user interface data from one machine to another leads to differences that can create inconsistencies in the data received by the client computer. For example, the remote computer may be operating at a different screen resolution or font scaling (e.g., high dots-per-inch (DPI)) than the client computer. Even if the client computer and remote computer have identical screen resolutions and sizes, the remote applications perceive themselves as being displayed on a desktop; whereas from the local point of view, they are on a remote desktop within a window on the local desktop. Being within a window means that the actual coordinates at which the remote UI is displayed locally are not the same as the coordinates at which the remote UI “thinks” it is being displayed. Therefore, the UI infrastructure accounts for this by adjusting coordinates to account for the host window's location and any scaling that is applied within it. A similar issue also happens with keyboard focus. For example, a remote button might think it has the keyboard focus; but if the local window does not have focus, then from end user's point of view, the button does not really have keyboard focus.

In some embodiments, the remote automation system translates coordinates and other data that is related to the remote computer to an appropriate format for the client computer. For coordinates, this may include adding an offset to account for the location of the remote desktop window on the client computer. A remote machine might have a different screen resolution than the local machine, and the system corrects the graphics coordinates when they move between machines to make them appear correct on the local machine. For example, this is helpful for AT applications like magnifiers that users expect to magnify the correct portion of the screen. The system may identify and convert any POINT and RECT types and update them appropriately so that they represent the location in the local client window, not in the remote desktop.

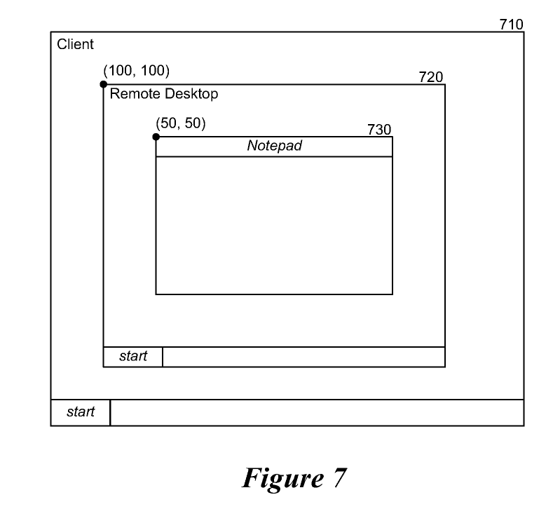

FIG. 7 is a display diagram that illustrates automation data translation performed by the remote automation system, in one embodiment. A client desktop 710 contains a remote desktop window 720 that displays the contents of the desktop of a remote computer. The remote desktop window 720 is located at screen coordinates (100, 100) on the client desktop 710. The remote desktop window 720 is displaying an application window 730 at screen coordinates (50, 50) on the remote desktop. Before providing the location of the application window 730 to local applications running on the client computer, the remote automation system translates the coordinates received from the remote computer to their correct values for the client computer. For example, in this instance the application window 730 is located at screen coordinates (150, 150) on the client computer, so the system provides these values to requesting applications running on the client computer.

From the foregoing, it will be appreciated that specific embodiments of the remote automation system have been described herein for purposes of illustration, but that various modifications may be made without deviating from the spirit and scope of the invention. For example, although remote automation in the context of AT applications has been described, other applications that use automation data locally may also benefit from the remote automation described as users increasingly rely on remote connections to computers. Accordingly, the invention is not limited except as by the appended claims.

I/We claim:

1. A computer-implemented method for providing automation data from a remote computer to a client computer, the method comprising:
receiving at the remote computer a request over a network for automation data related to an application running on the remote computer;
requesting automation data from the application running on the remote computer;
collecting automation data received from the application;
serializing the automation data to prepare the data for transmission to the client computer; and
transmitting the serialized automation data to the client computer in response to the request.

2. The method of claim 1 wherein receiving the request comprises receiving the request through a Microsoft Terminal Services connection.

3. The method of claim 1 wherein the application implements a standard interface for retrieving automation data.

4. The method of claim 1 wherein the application provides custom UI automation data.

5. The method of claim 1 wherein the application includes executable instructions for handling custom UI item patterns.

6. The method of claim 1 wherein collecting automation data comprises gathering information about one or more properties of UI items associated with the application and organizing the data into a hierarchical format.

7. The method of claim 1 wherein serializing the automation data comprises placing the automation data into one or more packets for transmission.

8. A computer system for remoting extensible accessibility information, the system comprising:
an information gathering component configured to gather accessibility information from an application running on a remote computer;
a serializing component configured to marshal the gathered accessibility information into a format suitable for transmission over a network;
a first transport component configured to transmit the marshaled accessibility information over the network to a client computer;
a second transport component configured to receive marshaled accessibility information; and
a deserializing component configured to deserialize the accessibility information and provide the deserialized accessibility information to an application running on the client computer.

9. The system of claim 8 further comprising a UI item data store configured to store information about each user interface property, event, and pattern that is accessible through the system, wherein the UI item data store contains one or more tables of pre-defined and application-provided UI items.

10. The system of claim 8 further comprising a coordinate translation component configured to reconcile inconsistencies in the accessibility information caused by differences in the remote computer and the client computer.

11. The system of claim 10 wherein the remote and client computers display a user interface element at different locations and the coordinate translation component modifies coordinates in the accessibility information based on locations of UI items on a desktop of the client computer.

12. The system of claim 8 further comprising:
an item registration component configured to handle requests from applications to register new UI item properties; and
an identifier assignment component configured to assign identifiers to new UI properties registered by applications.

13. The system of claim 12 wherein the identifier assignment component is further configured to assign identifiers such that no two UI properties in a particular process or associated with a particular automation interface instance have the same identifier.

14. The system of claim 12 wherein the item registration component is further configured to receive information about each property, including a name and description.

15. The system of claim 8 wherein the information gathering component is further configured to interface with proxies that translate accessibility data from a common format into a format of the system.

16. A computer-readable medium encoded with instructions for controlling a computer system to deserialize automation data received from a remote computer, by a method comprising:
sending a request for automation data from a client computer to a remote computer;
receiving a response including serialized automation data for one or more remote applications;
deserializing the automation data to produce an in-memory representation of the automation data from the received response;
translating one or more coordinates in the deserialized automation data to adjust for differences in the remote computer and the client computer; and
providing the translated automation data to a local application on the client computer.

17. The computer-readable medium of claim 16 wherein the request includes information identifying an application window being displayed by the client computer of an application running on the remote computer.

18. The computer-readable medium of claim 16 wherein the automation data identifies a type and location of UI elements displayed by the remote applications.

19. The computer-readable medium of claim 16 wherein the automation data includes at least one of a property, an event, and a pattern associated with a UI item.

20. The computer-readable medium of claim 16 wherein the in-memory representation comprises one or more hierarchical data structures with logically arranged UI items.
